(19) United States
(12) Patent Application Publication
(10) Pub. No.: US 2014/0195984 A1
(43) Pub. Date: Jul. 10, 2014

(54) ANALYTIC FRAMEWORKS FOR PERSONS OF INTEREST

(71) Applicant: NORTHEASTERN UNIVERSITY, Boston, MA (US)

(72) Inventors: Javed ASLAM, Weston, MA (US); Matthew EKSTRAND-ABUEG, Boston, MA (US); Nikos PASSAS, Medfield, MA (US); Ravi SUNDARAM, Cambridge, MA (US); Saber Shokat FADAEE, Boston, MA (US)

(73) Assignee: NORTHEASTERN UNIVERSITY, Boston, MA (US)

(21) Appl. No.: 14/149,289

(22) Filed: Jan. 7, 2014

Related U.S. Application Data
(60) Provisional application No. 61/749,704, filed on Jan. 7, 2013.
(60) Provisional application No. 61/749,719, filed on Jan. 7, 2013.
(60) Provisional application No. 61/749,759, filed on Jan. 7, 2013.

(51) Int. Cl. G06F 3/0484

(52) U.S. Cl. CPC G06F 3/0484
USPC 715/853

(57) ABSTRACT

The present systems and methods relate to frameworks for identifying persons of interest identified through datasets collected from law-enforcement agencies, financial institutions, or other public resources. The present systems represent network data regarding individuals and explicit connections between them as a network graph. The present systems determine a statistical model representing the network graph, the statistical model generating hidden parameters for decomposing and projecting the network graph onto a space of baseline communities. The present systems categorize cliques of nodes in the network graph as the space of baseline communities and infer a category for a received potential person of interest by determining a node corresponding to the received potential person of interest, and associating a clique from the categorized cliques to the node corresponding to the received potential person of interest, where the inferred category for the potential person of interest identifies the potential person of interest as suspicious.

### CROSS REFERENCE TO RELATED APPLICATIONS

This application claims priority under 35 U.S.C. §119(e) to U.S. Provisional Application No. 61/749,704 entitled “Automatic Tool for Scouring the Internet and Generating Names Linked to Illegal Activities to Facilitate Detection and Reporting of Suspicious Activities,” U.S. Provisional Application No. 61/749,719 entitled “Generation and Ranking of Names by Network Analysis,” and U.S. Provisional Application No. 61/749,759 entitled “Automated Analysis of Rules for Creating a More Efficient Rules Set Thus Enabling a Scalable and Performant Rules Engine,” all filed Jan. 7, 2013, each of which is incorporated by reference herein in its entirety.

### TECHNICAL FIELD

The present disclosure relates to methods, apparatus and systems for computational frameworks for identifying and analyzing persons of interest.

### BACKGROUND

Organizations such as financial institutions or law enforcement agencies attempt to identify persons of interest. For example, financial institutions may be required due to regulations to detect and report to designated authorities suspicious transactions or activities that could potentially relate to money laundering, terrorism, corruption, sanctions violations, and proliferation financing activities. Each financial institution typically operates its own compliance unit or financial intelligence unit by combining third-party vendor services and in-house systems to screen transactions and patterns for suspicious activities. Additionally, significant and intensive human analysis is used due to poor quality of results from traditional automated detection tools.

Although such organizations would like to identify persons of interest, traditional automated detection tools used by these organizations only support narrow parameters for name matching to third-party vendor databases, and existing media scans may miss many suspicious activities (i.e., activities that should be identified as suspicious are instead false negatives). Furthermore, imprecise transaction filtering rules in the automated tools may generate many false positives (i.e., identifying transactions as suspicious that are actually benign).

For example, banks are required to report transactions or accounts that may be linked to illegal activities. The current process used at one bank includes manual identification of persons of interest using published lists of politically exposed persons, suspected and confirmed offenders and institutions, and substantially manual scanning of media outlets for related articles and cross-checking against internal databases. The banks then identify accounts and transactions associated with the identified persons of interest using a manually created collection of processing rules. Traditionally these rules for filtering transactions are created manually. These rules result in high numbers of false positives (i.e., transactions that are flagged as suspicious but ultimately benign), and the rules can be difficult to understand and interpret.

Research has been conducted into characterizing and classifying individuals by determining structural differences between different types of social networks and using these differences predictively. For example, some research has focused on social media such as Facebook® and Twitter®, within which systems attempt to characterize and classify different types of individuals such as leaders, followers, and influencers.

Statistical network models have also been studied to demonstrate interactions among individuals in different contexts. Such network models have been used to analyze social relationships, communication networks, publishing activity, terrorist networks, and protein interactions. Researchers have further attempted to model community structure of a network directly, to analyze latent community structure behind certain interactions. Singular Value Decomposition (SVD) may decompose an adjacency matrix that represents a network into weighted linear transformations for easier analysis. Similarly, graphlet decomposition may decompose a weighted network (i.e., a network that assigns different weights to connections or edges between nodes), but other methods such as power graphs are needed to apply graphlet decomposition to unweighted networks.

### SUMMARY OF THE DISCLOSURE

The present disclosure relates to analytic frameworks for persons of interest.

Certain embodiments include systems for identifying persons of interest using network data. The system includes a memory, a display, and at least one processor coupled to the memory and to the display. The memory may store network data regarding persons of interest. The network data may be stored as a network graph of persons of interest. The network graph may represent individual people as nodes in the network graph and connections between the people as edges in the network graph. The display may render a computer-implemented user interface regarding the persons of interest. The processor may be configured to determine a statistical model representing the network graph. The statistical model may generate hidden parameters modeling the network data, for decomposing and projecting the network graph onto a space of baseline communities. The processor may be further configured to categorize cliques of nodes in the network graph as the space of baseline communities based at least in part on the statistical model. The processor may be further configured to infer a category for a received potential person of interest by determining a node corresponding to the received potential person of interest and associating a clique from the categorized cliques of nodes to the node corresponding to the received potential person of interest. The inferred category for the potential person of interest identifies the potential person of interest as suspicious. The processor may also be configured to render, using the display, the inferred category for the received person of interest.

Certain embodiments include methods for identifying persons of interest using network data. The methods may include storing, in a computer memory, network data regarding persons of interest. The network data may be stored as a network graph of persons of interest. The network graph may represent individual people as nodes in the network graph and connections between the people as edges in the network graph. The methods may further include rendering, on a display, a user interface regarding the persons of interest. The methods may further include determining a statistical model representing the network graph. The statistical model may generate hidden parameters modeling the network data, for decomposing and projecting the network graph onto a space of baseline communities. The methods may further include categorizing cliques of nodes in the network graph as the space of baseline communities based at least in part on the statistical model. The methods may further include inferring a category for a received potential person of interest by determining a node corresponding to the received potential person of interest and associating a clique from the categorized cliques of nodes to the node corresponding to the received potential person of interest. The inferred category for the potential person of interest may identify the potential person of interest as suspicious. The methods may also include rendering, using the display, the inferred category for the received person of interest.

Certain embodiments include non-transitory computer program products for identifying persons of interest using network data. The computer program products are tangibly embodied in a computer-readable medium. The computer program product may include instructions operable to cause a data processing apparatus to store, in a computer memory, network data regarding persons of interest. The network data may be stored as a network graph of persons of interest. The network graph may represent individual people as nodes in the network graph and connections between the people as edges in the network graph. The computer program product may further include instructions operable to cause the data processing apparatus to render, on a display, a user interface regarding the persons of interest. The computer program product may further include instructions operable to cause the data processing apparaturs to determine a statistical model representing the network graph. The statistical model may generate hidden parameters modeling the network data, for decomposing and projecting the network graph onto a space of baseline communities. The computer program product may further include instructions operable to cause the data processing apparatus to categorize cliques of nodes in the network graph as the space of baseline communities based at least in part on the statistical model. The computer program product may further include instructions operable to cause the data processing apparatus to infer a category for a received potential person of interest by determining a node corresponding to the received potential person of interest and associating a clique from the categorized cliques of nodes to the node corresponding to the received potential person of interest. The inferred category for the potential person of interest may identify the potential person of interest as suspicious. The computer program product may also include instructions operable to cause the data processing apparatus to render, using the display, the inferred category for the received person of interest.

The embodiments described herein may include additional aspects. For example, the inferred categories may include Suspicious Individuals, Convicted Individuals, Legal/Lawyer Professionals, Political Individuals, Politically Exposed Individuals, Terrorists, Suspected Terrorists, Bank, Blacklisted, Corporate, Country, Crime, Diplomat, Embargo, Individual, Legal, Military, Organization, Political, Port, Religion, Terrorism, Trade, or Vessel. The statistical model may generate the hidden parameters for reconstructing the network graph. The categorizing the cliques of nodes may further include (i) determining power relationships between baseline cliques, and (ii) determining commonalities between the network graph and the baseline cliques. The network graph may be unweighted, the network graph may not adhere to a power law, and the network graph may not exhibit small world phenomena. The categorizing the cliques of nodes may further include identifying maximal cliques in the network graph using the Bron-Kerbosch algorithm. The determining the parameters for reconstructing the network graph may further include solving for the parameters according to a least squares solution.

### BRIEF DESCRIPTION OF FIGURES

Various embodiments of the present systems and methods are disclosed in the following description and accompanying drawings, in which like elements are referenced with like numerals. These drawings should not be construed as limiting the present disclosure, but are intended to be exemplary only.

FIG. 1 illustrates an exemplary system implementing analytic frameworks for persons of interest, in accordance with certain embodiments of the present invention.

FIG. 2A illustrates an exemplary network graph representing persons of interest and links between them, in accordance with certain embodiments of the present invention.

FIG. 2B illustrates exemplary activities, categories, or types associated with persons of interest in the network graph, in accordance with certain embodiments of the present invention.

FIG. 3 illustrates an exemplary process for inferring a social category for a person of interest, in accordance with certain embodiments of the present invention.

FIGS. 4A-4I illustrate exemplary results from testing traditional systems and methods against the present systems and methods, in accordance with certain embodiments of the present invention.

FIG. 5A illustrates an exemplary process for inferring hidden links among persons of interest in a network graph, in accordance with certain embodiments of the present invention.

FIG. 5B illustrates an exemplary process for detecting persons of interest in a network graph, in accordance with certain embodiments of the present invention.

FIG. 5C illustrates an exemplary process for inferring an associated category for a person of interest in a network graph, in accordance with certain embodiments of the present invention.

FIG. 6 illustrates an exemplary process for generating names of persons of interest linked to illegal activities, in accordance with certain embodiments of the present invention.

FIG. 7 illustrates an exemplary database schema for generating names of persons of interest linked to illegal activities, in accordance with certain embodiments of the present invention.

FIGS. 8A-8C illustrate exemplary user interfaces for generating names of persons of interest linked to illegal activities, in accordance with certain embodiments of the present invention.

FIG. 9 illustrates an exemplary process for automated analysis of rule sets, in accordance with certain embodiments of the present invention.

FIG. 10 illustrates an exemplary computer system implementing the present analysis framework for persons of interest, in accordance with certain embodiments of the present invention.

### DESCRIPTION

The present systems and methods relate to computational frameworks for identifying and analyzing persons of interest. The persons of interest may be identified through datasets collected from law-enforcement agencies, financial institutions, and other public resources. These datasets generally represent public resources that characterize individuals and explicit connections between them. The present systems and methods may identify and analyze persons of interest according to the following embodiments: (1) network graph analysis, (2) scouring the Internet to generate names of persons of interest linked to illegal activities, and (3) automated analysis of rules regarding transactions relating to persons of interest, so as to create more efficient rule sets for identifying suspicious transactions.

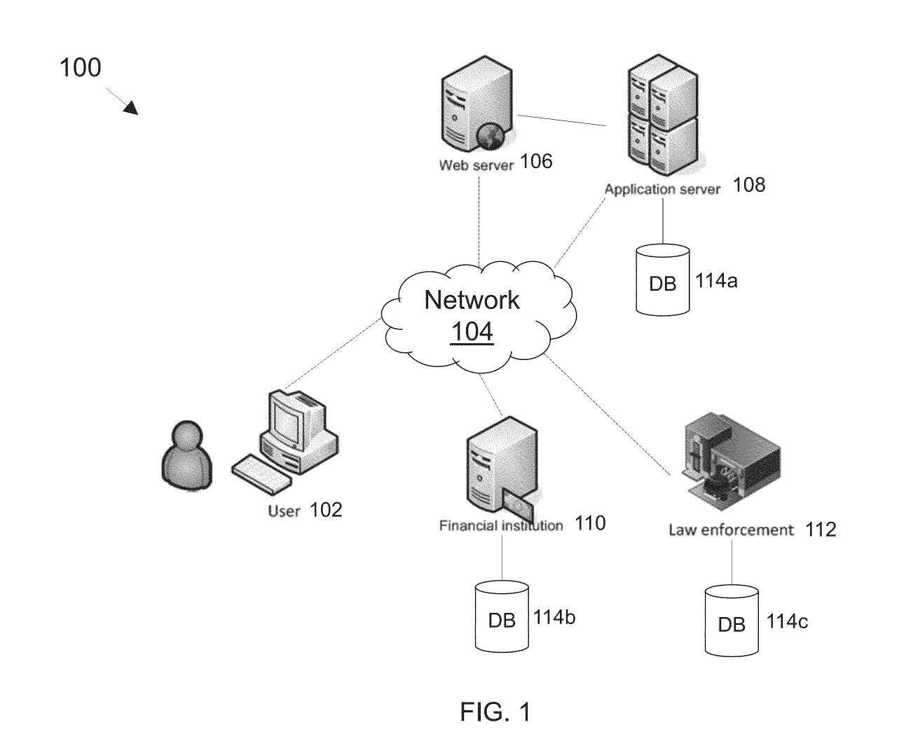

FIG. 1 illustrates an exemplary system 100 implementing analytic frameworks for persons of interest, in accordance with certain embodiments of the present invention. System 100 includes user 102 in communication with network 104. Web server 106, application server 108, financial institution 110, and law enforcement agency 112 are also in communication with network 104.

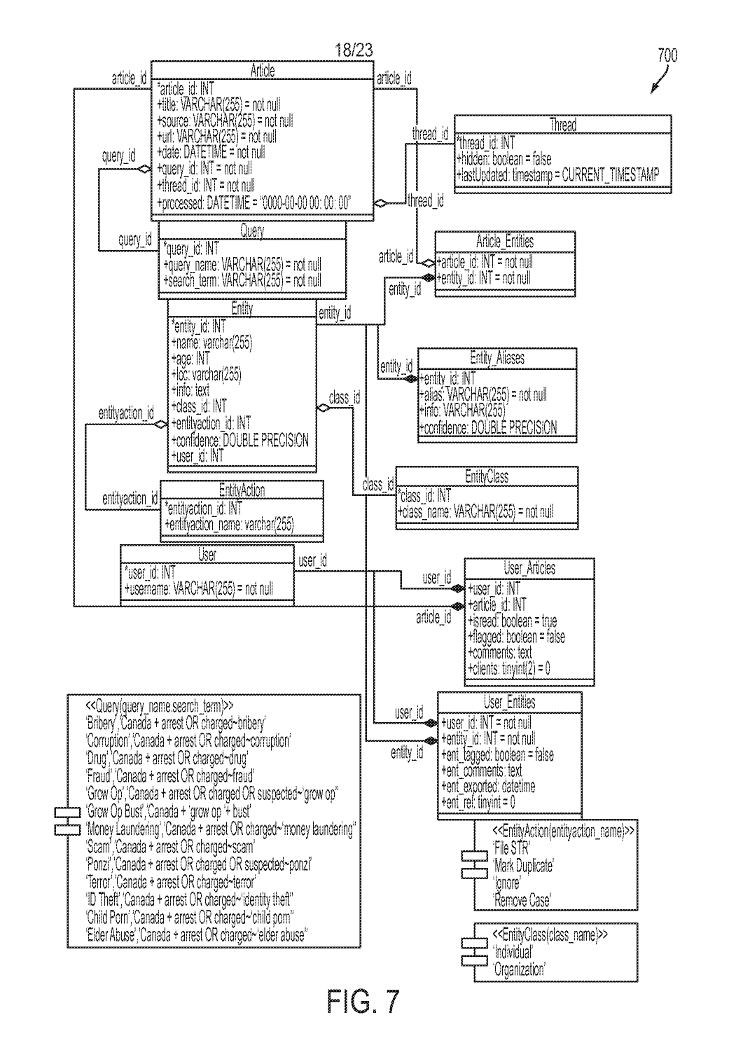

Application server 108 communicates over network 104 with financial institution 110 and/or law enforcement agency 112. For example, application server 108 may request from financial institution 110 lists of daily accounts and transactions for use in the present analytic framework for persons of interest to determine whether any accounts or transactions may be correlated with persons of interest. Financial institution 110 may store the accounts and transactions in database 114b. Application server may use database 114a to analyze the persons of interest and scan media potentially related to the persons of interest. An example database schema for database 114a is illustrated in further detail in FIG. 7 and discussed in the accompanying description. Similarly, application server 108 may work with law enforcement agency 112 to identify initial persons of interest. Law enforcement agency 112 may itself track civil and criminal activity histories of persons of interest in database 114c.

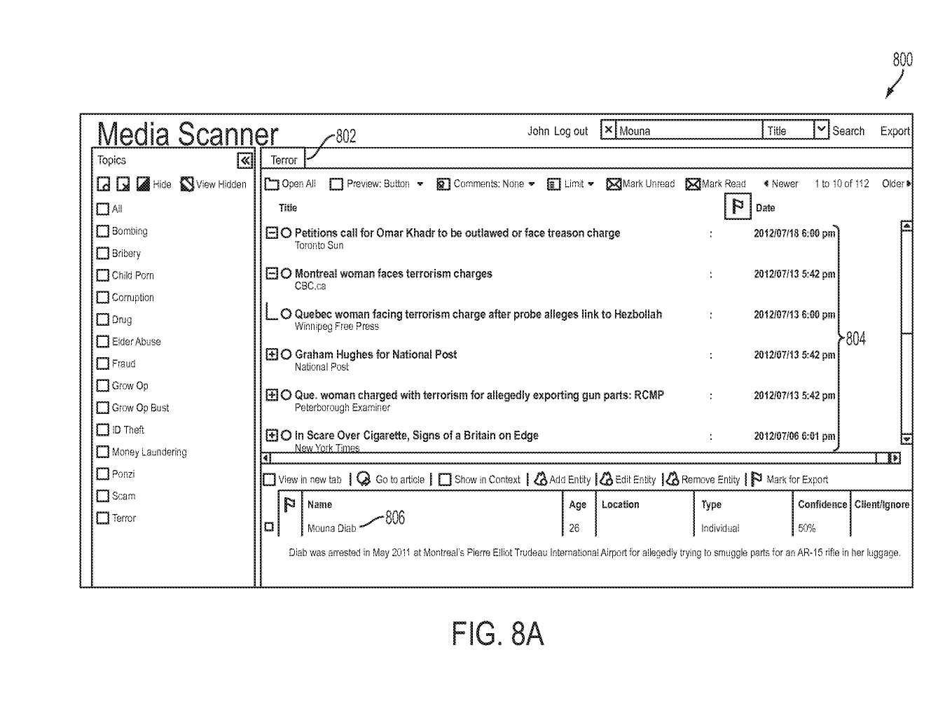

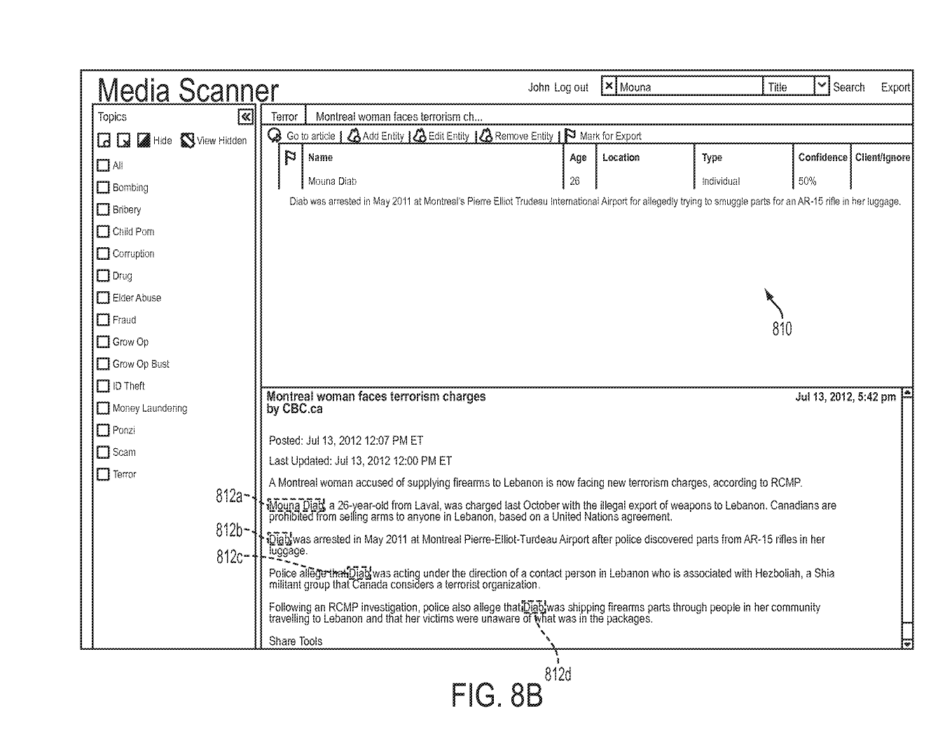

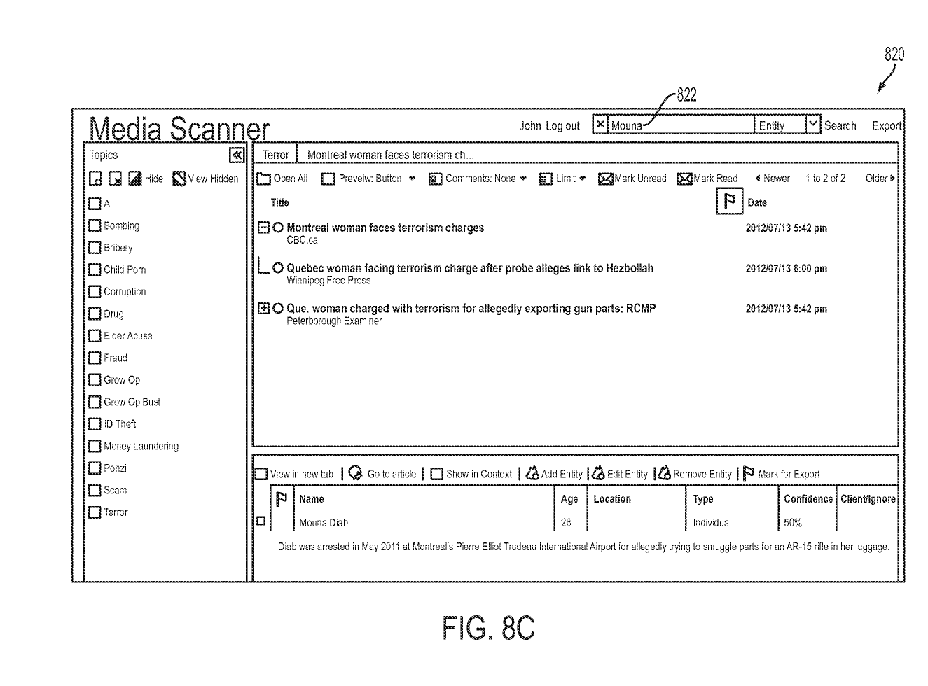

Web server 106 may transmit user interfaces to user 102 over network 104 for the present analytic framework for persons of interest. Example user interfaces for the present analytic framework for persons of interest are illustrated in further detail in FIGS. 8A-8C and discussed in the accompanying description.

### Analyzing Persons of Interest Using Network Graph Analysis

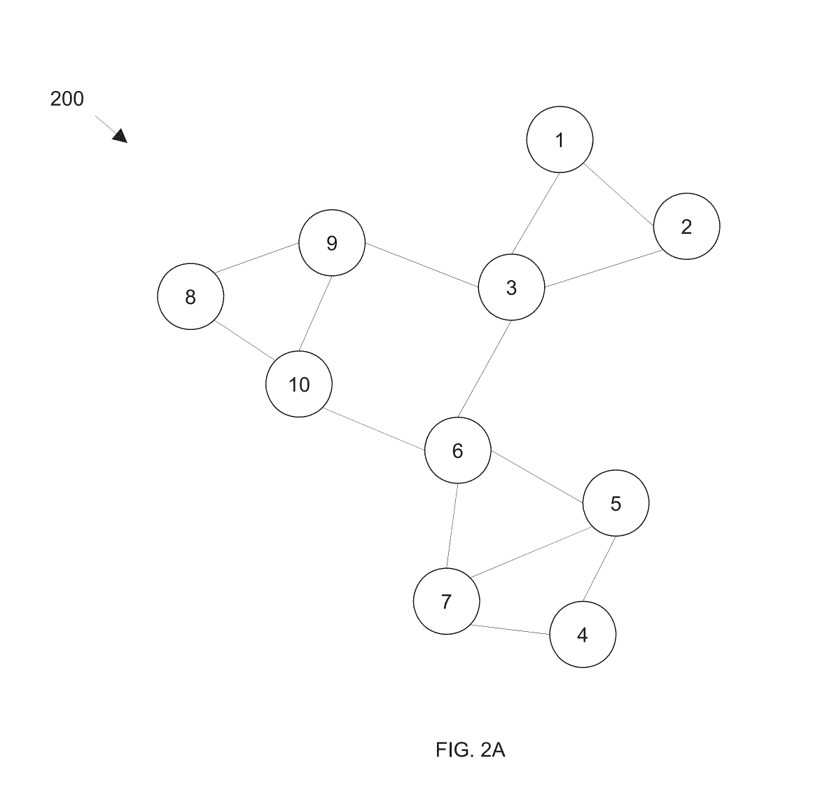

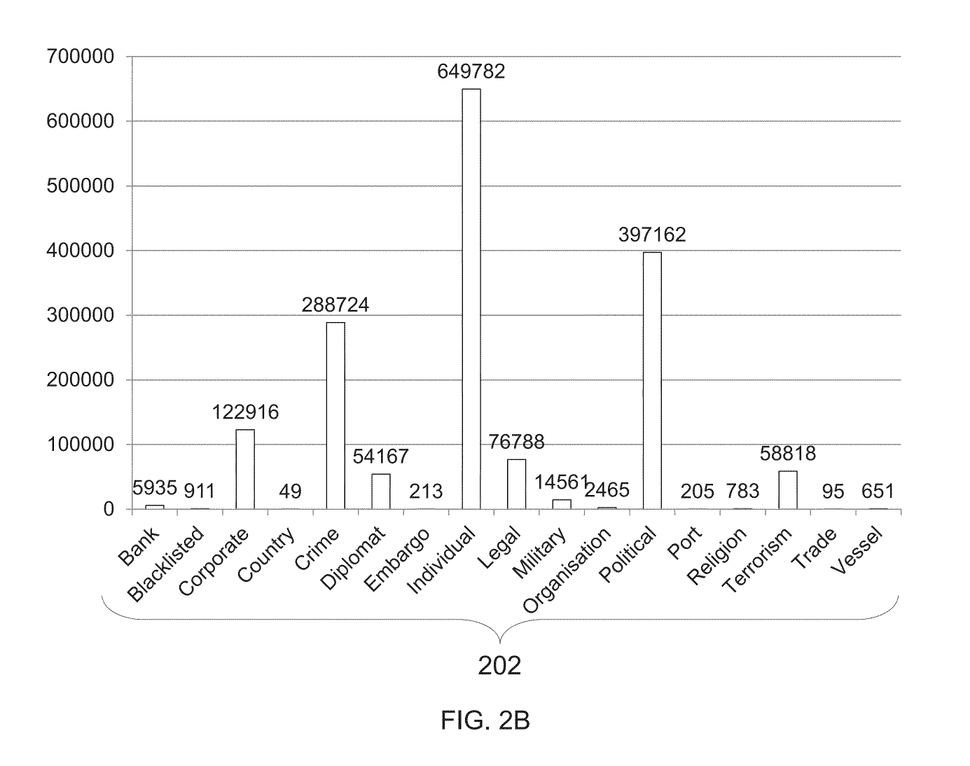

FIG. 2A illustrates an exemplary network graph 200 representing persons of interest and links between them, in accordance with certain embodiments of the present invention. Network graph 200 illustrates 10 persons of interest. Network graph 200 includes explicit links, or connections, between individuals. Example clusters of individuals include {8, 9, 10}, {1, 2, 3}, {3, 9, 10, 6}, {6, 7, 5}, {7, 5, 4}, and {6, 7, 5, 4}. An explicit link refers to a connection that is visible as an edge in network graph 200. In contrast, hidden links may represent implicit connections between persons of interest in network graph 200. For example, there could be a hidden link between individuals 6 and 4 in network graph 200 (not shown).

As described earlier, the persons of interest in network graph 200 may be gathered from law-enforcement agencies, financial institutions, and similar organizations within which one would like to characterize and classify different types of persons of interest. The persons of interest may be gathered from other public institutions and commercial sources, including but not restricted to: the United Nations, World-Check (from Thomson Reuters), Interpol, Factiva (from Dow Jones), OFAC, Factcheck, RCMP, or various police web sites.

In practice, network data gathered from these organizations is qualitatively different from network data gathered from social media on which existing research has traditionally been performed. Traditional research focuses on inferring connections among individuals by analyzing private activities of specific individuals in social media. Furthermore traditional social networks demonstrate common properties such as adhering to the power law and small world phenomena. The power law is a variation on preferential attachment models for network graphs. Small world phenomena indicate that a network graph exhibits short paths of connections that link most people in social spheres (e.g., for connected chains, the farthest one individual tends to be from another individual is six degrees of separation). In contrast, the present system uses updated techniques to analyze network data from public resources via these organizations.

FIG. 2B illustrates exemplary activities, categories, or types 202 associated with persons of interest in the network graph, in accordance with certain embodiments of the present invention. FIG. 2B also illustrates counts of persons of interest found within a sample network graph. For example, 5,935 individuals in a sample network graph were associated with the “Bank” activity. Example types 202 may include Bank, Blacklisted, Corporate, Country, Crime, Diplomat, Embargo, Individual, Legal, Military, Organization, Political, Port, Religion, Terrorism, Trade, and Vessel.

Categories 202 may further include other types in addition to or instead of the types illustrated in FIG. 2B. For example, for purposes of the example generative statistical network model that follows, the categories used are:
Suspicious Individuals: individuals who appeared on sanctioned lists, or been arrested or detained but not convicted of any crime (see Convicted Individuals)
Convicted Individuals: individuals convicted of any crime
Legal Individuals: persons currently employed in a legal profession
Political Individuals: elected officials, heads of political parties, or persons who have held or currently hold political positions now or in the past

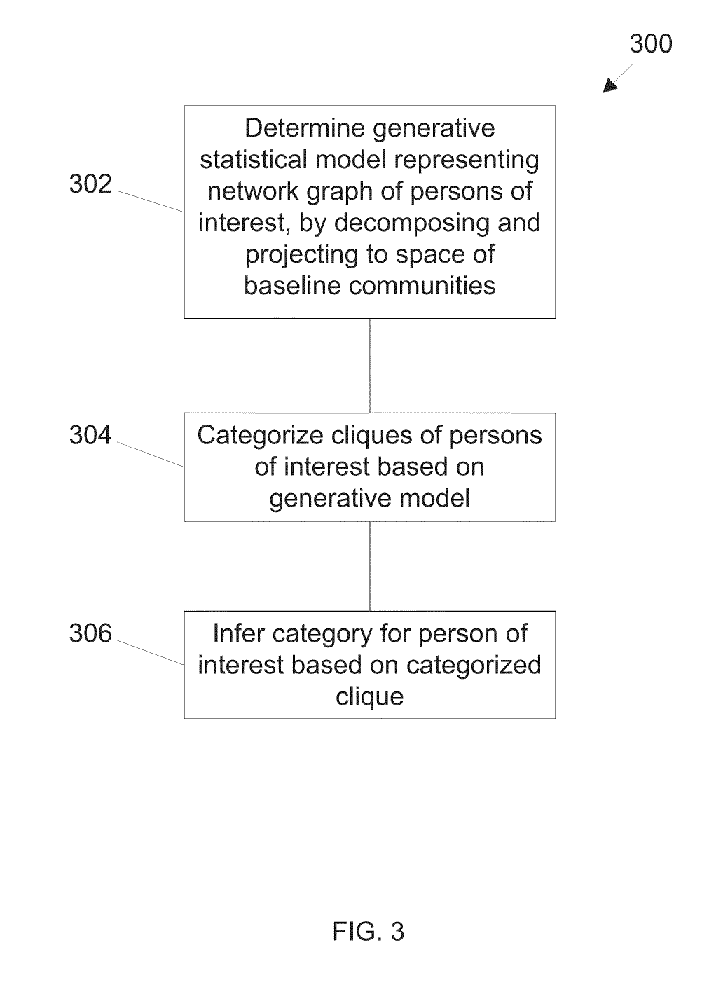

FIG. 3 illustrates an exemplary process 300 for inferring a social category for a person of interest, in accordance with certain embodiments of the present invention. The present system determines a generative statistical model that represents a network graph of persons of interest (step 302). A generative statistical network model, also referred to as a “network graph model,” determines a few “essential” parameters that represent the graphical structure of the network graph. Generally, the success of the present generative statistical network model indicates high development potential of statistics-based technologies for categorizing and drawing inferences about sub-networks of people of interest entirely through the structure of their network graph. The present generative statistical model is presented in further detail below.

In some embodiments, the generative model represents a stochastic process based on a Bernoulli trial for generating networks. The generative model decomposes the input network graph and projects the network graph to the space of baseline communities (which correspond to cliques in the present generative model).

The present system categorizes cliques or sub-networks of persons of interest based on the determined generative model (step 304). In some embodiments, process 300 determines a parameter referred to in the generative model as a vector μ. Generally, μ represents a network in the present network analysis applications. In some embodiments, as described in further detail below, the values for μ can be determined according to the equation μ=A⁻¹d. Matrix A represents power relationships between baseline clusters as part of network reconstruction. Vector d presents commonalities between a given network and its baseline communities.

The present system infers a category for the person of interest, based on the categorized cliques (step 306). Parameters μ, A, and d described above allow the generative model to discriminate between different types of networks. For example, the present system is able to determine that a selected person of interest, e.g. node 1, might belong to a category such as Convicted Individuals that is associated with a particular clique or sub-network. In some embodiments, the present system determines cliques and associated categories in the network graph using the Bron-Kerbosch algorithm. As described in further detail below, the Bron-Kerbosch algorithm may be used to identify maximal cliques in an undirected network graph.

### Generative Network Model

Given an adjacency matrix Y that represents a network (described following), the generative model infers the parameters that generate the network. The generative model begins by representing a network graph having N nodes (i.e., persons of interest) as an N×N adjacency matrix Y. In adjacency matrix Y, Y(r,s)=1 if node r is connected to node s and Y(r, s)=0 otherwise. Because the network graph is undirected, Y(r,s)=Y(s,r). For example, with reference to FIG. 2A and network graph 200, Y(1,2)=1 because there is an edge between node 1 and node 2. Similarly, Y(2,1)=1 because network graph 200 is undirected. However, Y(6,4)=0 because there is no (explicit) edge between node 6 and node 4. (As described in further detail later, there may be a “hidden link,” or implicit edge, between nodes 6 and 4.)

The generative model uses

Y=Bernoulli(Z) (Equation 1),

which means Y(r,s)=Y(s,r)=1 with probability Z(r,s), and Y(r,s)=Y(s,r)=0 with probability 1−Z(r,s) for all r>s. Since the network graph is undirected, matrix Z may be considered to be lower triangular, which means that all entries above Z's main diagonal are considered to be zeroes (the entries are represented symmetrically below Z's main diagonal). Lower triangular matrices make matrix equations easier to solve.

As described earlier, in some embodiments the generative model represents Z in a new space. Specifically, in some embodiments the generative model performs the following basis selection. The generative model chooses bases to reflect community structures among persons of interest in the network graph. In some embodiments, the generative model factorizes Z as

$$Z = {\sum }_{k = 1}^{K} {μ}_{k} {B}_{k} , \qquad ( Equation 2 )$$

where K represents the number of bases (i.e., the number of categories or communities), Bₖ is the kth lower triangular basis matrix (i.e., network), and μₖ represents the contribution of Bₖ to the network. The present system considers the bases to be cliques of the network. Each network is parameterized by the coefficients and bases that construct matrix Z, which represents the generating matrix for the network.

The generative model infers the parameters generating the network as follows. Assume the bases are selected as baseline cliques. The present system observes the likelihood [symbol] of network parameters μ according to the following equation:

$$ℒ ( {μ}_{1 \text{:} k} ) = {\prod }_{r > s \text{:} Y ( r , s ) = 1} Z ( r , s ) {\prod }_{r > s \text{:} Y ( r , s ) = 0} ( 1 - Z ( r , s ) ) . \qquad ( Equation 3 )$$

The present system estimates the parameters by maximizing their likelihood under the constraint 0≦Z(r,s)≦1 for all r>s. The likelihood is maximized when Z(r,s)=1 if Y(r,s)=1 and Z(r,s)=0 when Y(r,s)=0. Therefore,

$$Y = {\sum }_{k = 1}^{K} {μ}_{k} {B}_{k} \qquad ( Equation 4 )$$

may be used for the lower triangle of Y.

Unfolding Equation 4 yields

$$Y ( 2 , 1 ) = {μ}_{1} {B}_{1} ( 2 , 1 ) + … + {μ}_{K} {B}_{K} ( 2 , 1 ) \\ Y ( 3 , 1 ) = {μ}_{1} {B}_{1} ( 3 , 1 ) + … + {μ}_{K} {B}_{K} ( 3 , 1 ) \\ Y ( 3 , 2 ) = {μ}_{1} {B}_{1} ( 3 , 2 ) + … + {μ}_{K} {B}_{K} ( 3 , 2 ) \\ ⋮ \\ Y ( N , N - 1 ) = {μ}_{1} {B}_{1} ( N , N - 1 ) + … + {μ}_{K} {B}_{K} ( N , N - 1 ) \qquad ( Equation 5 )$$

The generative model defines two vectors

μ=(μ₁, . . . , μ_{K})^{T} (Equation 6),

b^{rs}=(B₁(r,s), . . . , B_{K}(r,s))^{T}

where K represents the number of bases (also referred to herein as cliques or communities), Bₖ is the kth lower triangular basis matrix (i.e., network), and μₖ represents the contribution of Bₖ to the network.

Based on Equation 6, the new objective function may be written as

$$J = {\sum }_{r > s} {( {μ}^{T} {b}^{rs} - Y ( r , s ) )}^{2} \qquad ( Equation 7 )$$

J is convex with respect to μ under the following constraints: 0≦μ^{T}b^{rs}≦1. In some embodiments, to solve the objective function (Equation 7) the present system can use constraint least squares solvers. Example constraint least squares solvers are described in C. L. Lawson and R. J. Hanson, Solving least squares problems, volume 161, SIAM, 1974, and S. P. Boyd and L. Vandenberghe, Convex optimization, Cambridge university press, 2004, the entire contents of both of which are incorporated by reference herein.

The exact generating parameters from the new representation are no longer needed for the network graph applications. By relaxing the constraints described above, the present generative model is able to use a simpler and more efficient algorithm. The present system may determine substantially optimal parameters by taking the derivative with respect to μ. The parameters may be determined to be substantially optimal when the derivative equals zero.

$$\frac{\partial J}{\partial μ} = 2 {\sum }_{r > s} {b}^{rs} ( {b}^{{rs}^{T}} μ - Y ( r , s ) ) \qquad ( Equation 8 )$$

Setting the derivative to zero in Equation 8 yields the solution

$$\begin{matrix}μ = {A}^{- 1} d , \\ where & ( Equation 9 ) \\ A = {\sum }_{r > s} {b}^{rs} {B}^{{rs}^{T}} \\ d = {\sum }_{r > s} Y ( r , s ) {b}^{rs} . & ( Equation 10 )\end{matrix}$$

A is a K×K matrix representing K communities or clusters, and d is a K×1 vector. As with Equation 7, Equation 10 remains a least squares problem to solve, but the computational complexity is significantly reduced from Equation 7 having O(N²) constraints.

As described earlier, the present generative model therefore finds which is used to represent a network, and which can stand-in for a network in the present network analysis applications.

Sample results from decomposing network graph 200 (shown in FIG. 2A) are shown in Table 1 below.

TABLE 1
μ within each cluster

| Cluster members | μ |
|---|---|
| {8, 9, 10} | 1.00 |
| {5, 6, 7} | 0.75 |
| {4, 5, 7} | 0.75 |
| {1, 2, 3} | 1.00 |
| {6, 10} | 1.00 |
| {3, 9} | 1.00 |
| {3, 6} | 1.00 |

Table 1 illustrates, for example, that the present generative model finds that nodes 8, 9, and 10 have a score of 1.00 and therefore appear more likely to form a cluster than, for example, nodes 5, 6, and 7.

In the equation μ=A⁻¹d, every entry in matrix A equals the number of edges shared by the two corresponding cliques. For example, if A(2,3)=1, then cliques 2 and 3 share 1 edge. Generally, then, matrix A encodes power relationships between baseline clusters as part of network reconstruction. The intersection between two bases shows how much one basis can overpower another as the bases are reconstructing a network. In contrast, vector d presents commonalities between a given network and its baseline communities. This equation therefore encodes the contribution of a community to a network. The present system chooses the coefficients of the generative model such that when the intersection of cluster 1 and other clusters are multiplied by their corresponding coefficients and added together, the result is a clearer understanding of the contribution of the first cluster to the network. The least squares solution described earlier is an efficient means of solving this equation, as the least squares solution attempts to account for as many clusters as possible.

As described earlier, basis selection can further help to identify communities associated with the network. For example, the present system can use the Bron-Kerbosch algorithm to identify all maximal cliques in an undirected network. The Bron-Kerbosch algorithm generally describes methods for finding cliques in undirected graphs in C. Bron and J. Kerbosch, Finding all cliques of an undirected graph, Communications of the ACM, 1973, the entire contents of which are incorporated by reference herein.

Advantageously, the present generative model provides a “multi-resolution” perspective of the network. This means the present system allows identifying communities with persons of interest through a variety of scales. Therefore, the present system allows location of the most natural and representative set of coefficients and bases according to the generative model described herein.

### Experimental Results

When compared against traditional methods of decomposing network graphs, the present generative statistical model exhibits a concise representation, and can discriminate successfully between different network types.

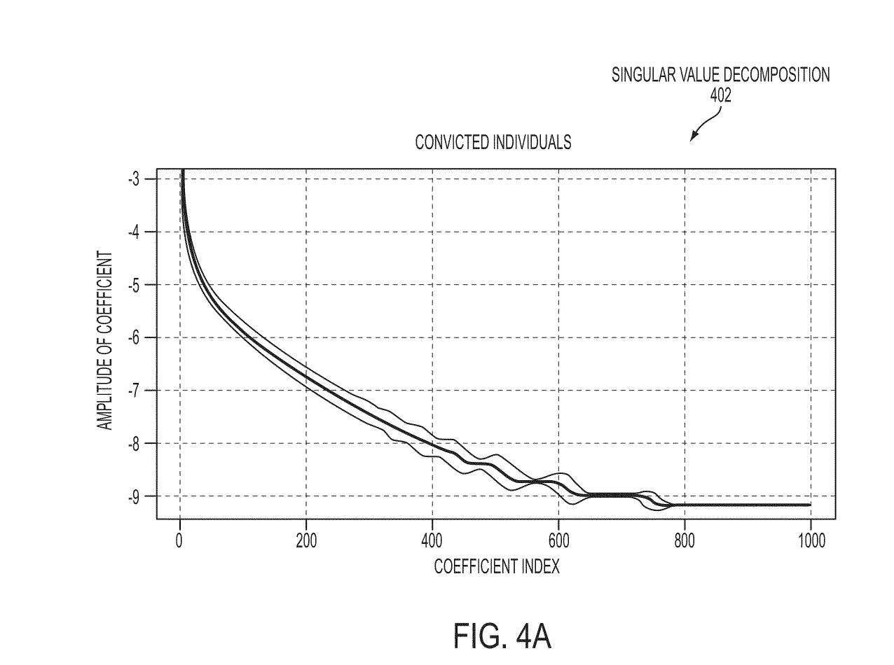

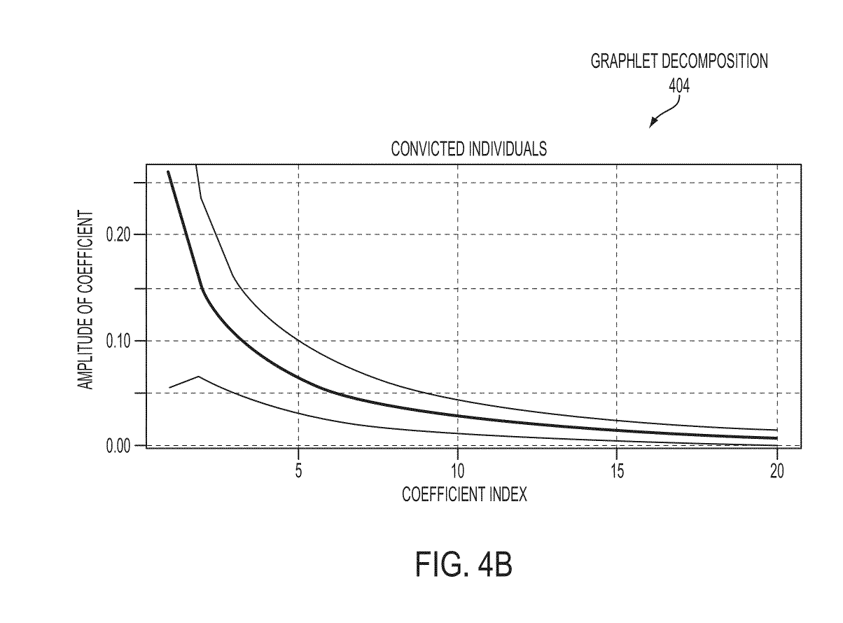

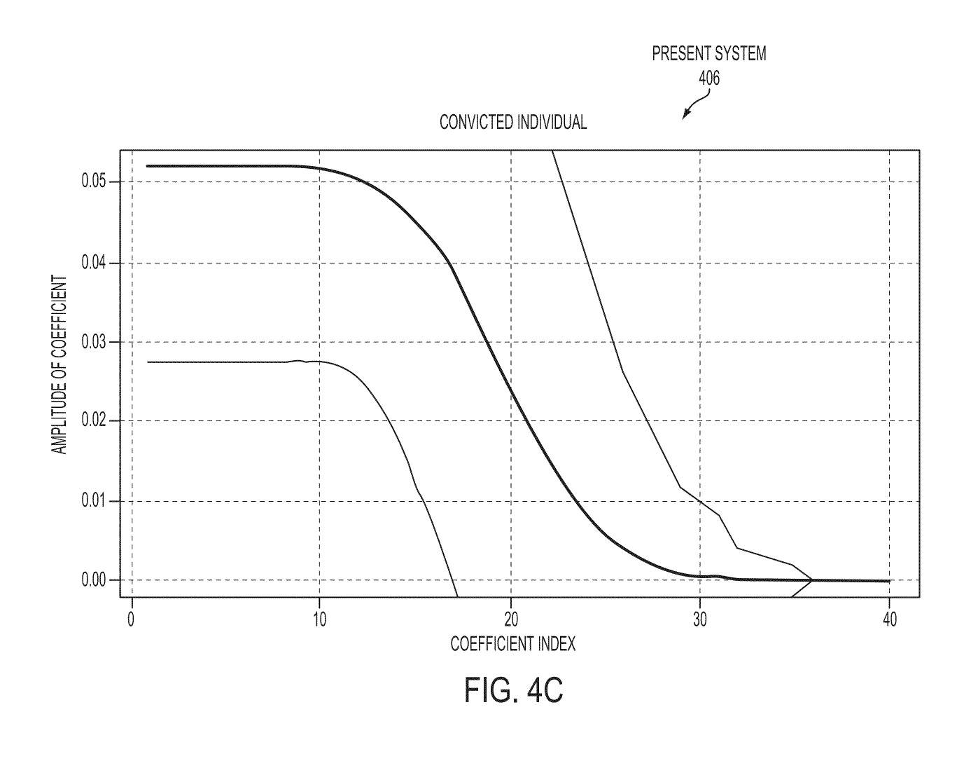

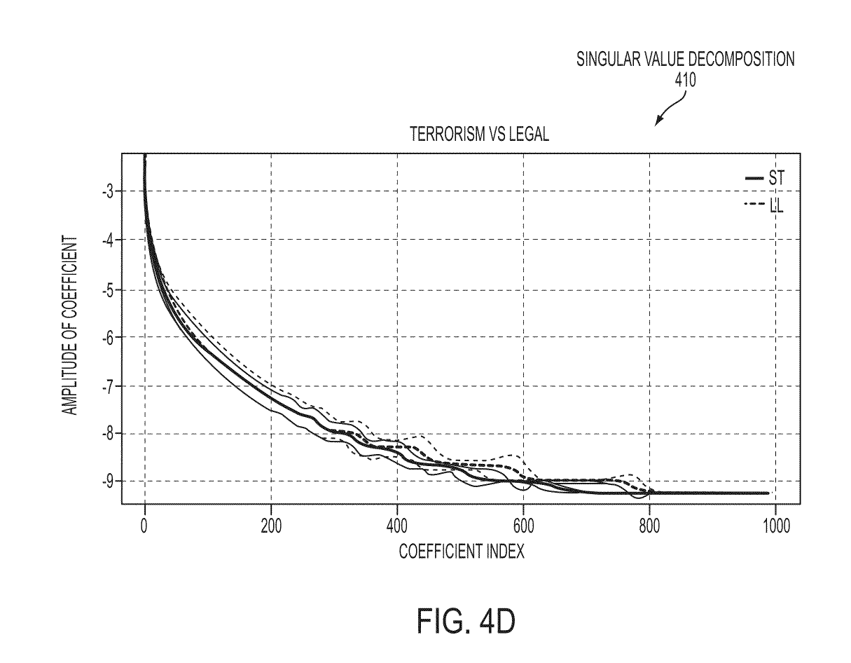

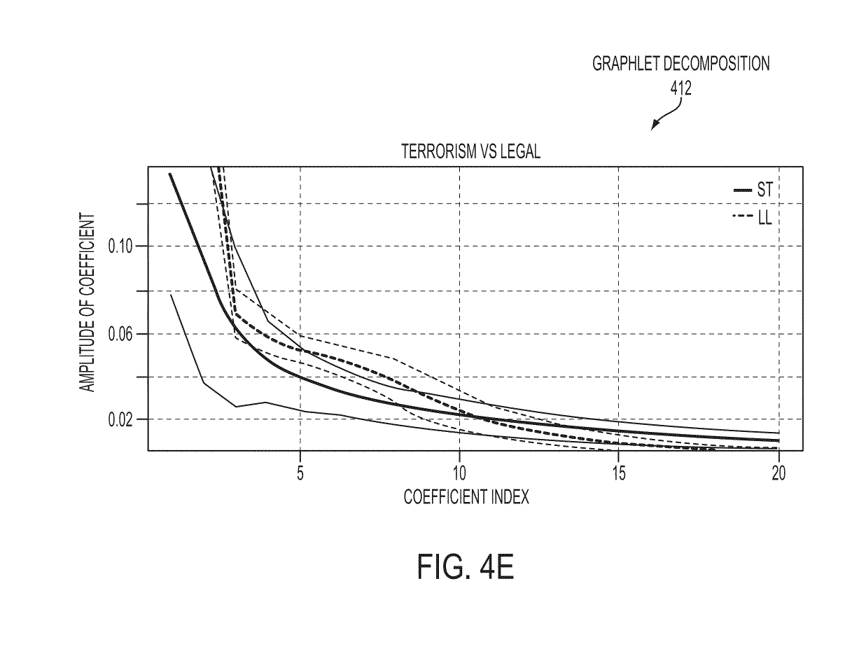

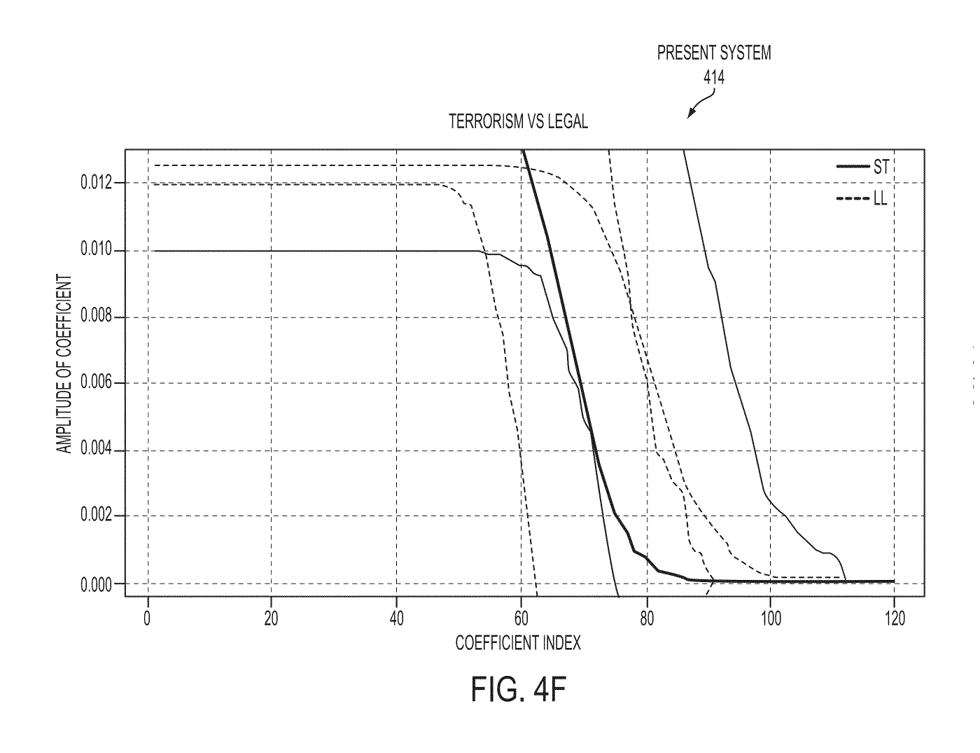

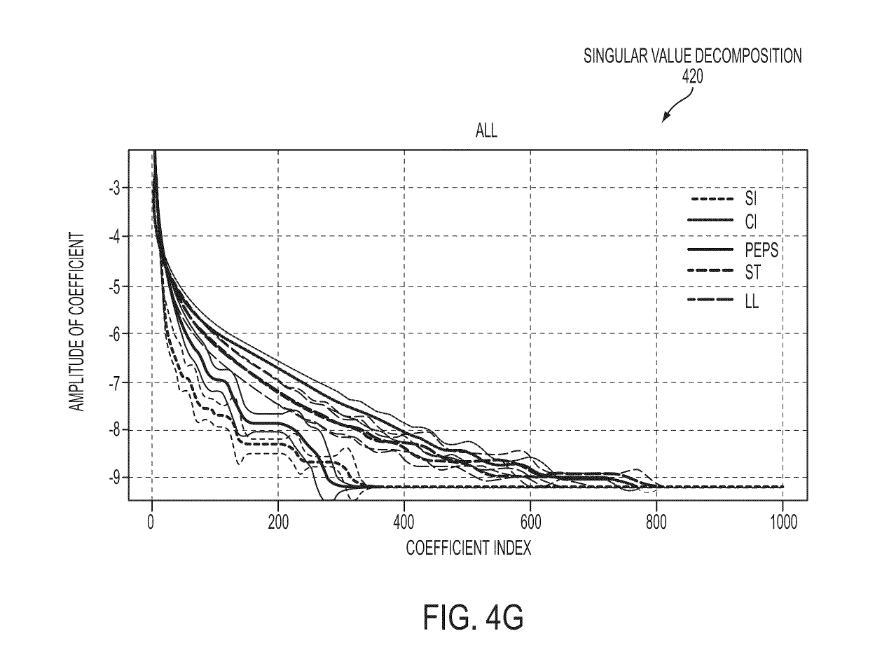

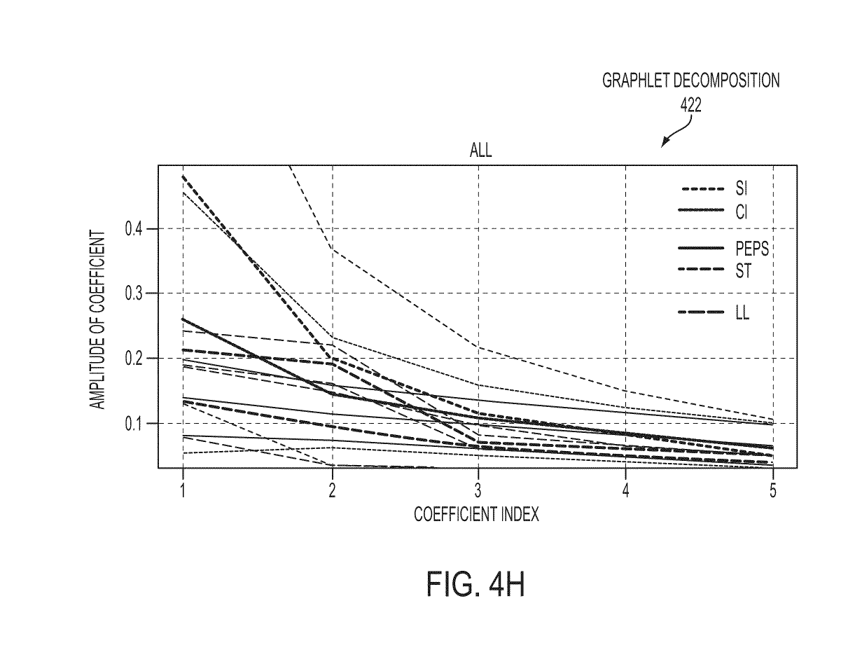

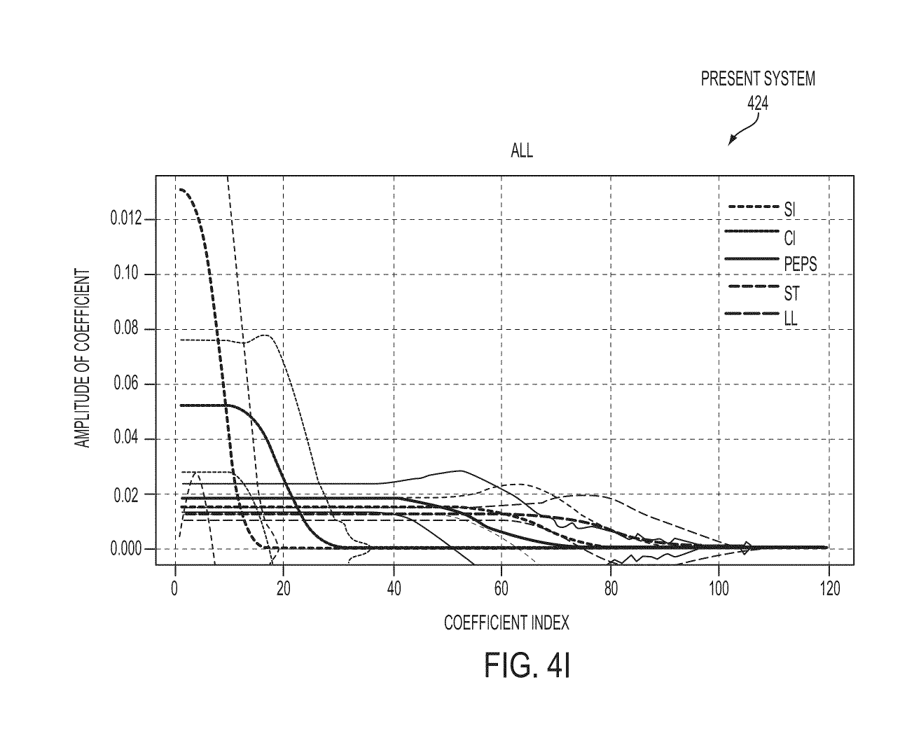

The present systems and methods were tested against a comprehensive dataset gathered and fused from a variety of public and commercial sources. The final dataset included 700,000 persons of interest, with 4 million (explicit) connections among them. The examples below were run against a filtered version of the comprehensive dataset, containing slightly less than 600,000 individuals. As described earlier, corresponding categories for the 600,000 individuals included: Suspicious Individuals, Convicted Individuals, Lawyers/Legal Professionals, Politically Exposed Persons, and Suspected Terrorists. For each category, a random induced subgraph of 1,000 nodes or vertices was chosen as a sample. FIGS. 4A-4I and the examples described herein illustrate tests of traditional singular value decomposition and traditional graphlet decomposition, compared with results from the present systems and methods.

FIGS. 4A-4C illustrate exemplary results from testing traditional systems and methods against the present systems and methods, in accordance with certain embodiments of the present invention. Graphs 402, 404, and 406 illustrate effective numbers of non-zero coefficients for traditional singular value decomposition (SVD) methods (graph 402, shown in FIG. 4A), traditional graphlet decomposition methods (graph 404, shown in FIG. 4B), and the present systems and methods (graph 406, shown in FIG. 4C). Bold lines in graphs 402-406 indicate average results from repeating 1,000 times the analysis of the data. Lighter lines in graphs 402-406 indicate results from taking a standard deviation of the data at a margin of 2. Graph 402 (shown in FIG. 4A) illustrates traditional singular value decomposition (SVD) of the network graph, in particular using eigen value decomposition. Eigen value decomposition is described in F. R. K. Chung, Spectral graph theory, American Mathematical Society, 1997, the entire contents of which are incorporated by reference herein. The average number of bases observed was around 800 for 1,000 vertices of the network graph. Graph 404 (shown in FIG. 4B) illustrates traditional graphlet decomposition results from the same tests. The average number of bases observed was about 20. Finally, graph 406 (shown in FIG. 4C) illustrates the results according to the present systems and methods. In particular, the present example included determining appropriate bases using the Bron-Kerbosch algorithm, described earlier. The present example then included determining matrix A and vector d, also as described earlier. The average number of bases observed was about 50.

To compare the ability of traditional singular value decomposition (SVD), traditional graphlet decomposition, and the present systems and methods to distinguish between different types of social networks, the present example included sampling 100 networks from each category described earlier, combining all the samples before running the K-means clustering algorithm (with 5 as the number of clusters), and repeating 100 times. The present example uses each network's top 20 largest coefficients. The present example also calculates the mean error of clustering (shown in Table 2). Also as indicated in Table 2, the present systems and methods often bases with the best ability to distinguish between the type of social network presented. Although traditional graphlet decomposition nominally outperforms the present systems and methods in two graphs, the present systems and methods are much easier and more efficient to obtain results that are quite close to the accuracy of traditional graphlet decomposition. As described later, in practice such difference is also negligible.

TABLE 2
Mean error of clustering with 20 coefficients

| | Traditional | Traditional | Present |
|---|---|---|---|
| Category | Eigen Value | Graphlet | Model |
| Suspicious Individuals | 0.51461 | 0.00817 | 0.0177 |
| Convicted Individuals | 0.71080 | 0.11535 | 0.0141 |
| Lawyers/Legal | 0.75006 | 0.10931 | 0.0153 |
| Professionals | | | |
| Politically Exposed | 0.6082 | 0.12195 | 0.0114 |
| Persons | | | |
| Suspected Terrorists | 0.65381 | 0.01303 | 0.0176 |

Generally, graphs 402, 404, and 406 compare the ability of traditional SVD and traditional graphlet decomposition to compress data, compared with the present systems and methods. Graph 402 (shown in FIG. 4A) illustrates that traditional SVD is inefficient for summarizing features of a network. Graph 404 (shown in FIG. 4B) illustrates that traditional graphlet methods produce a small feature space. The present representation also produces a small feature space, however, and the differences in size produced through these methods are negligible for real world applications. As described earlier, the 20 largest coefficients in the representation produced through the present systems and methods are sufficient to outperform traditional graphlet methods in terms of distinguishability and clustering.

FIGS. 4D-4F also illustrate exemplary results from testing traditional systems and methods against the present systems and methods, in accordance with certain embodiments of the present invention. Graphs 410, 412, and 414 illustrate the ability to discriminate between two different categories, using traditional singular value decomposition (SVD) methods (graph 410, shown in FIG. 4D), traditional graphlet decomposition methods (graph 412, shown in FIG. 4E), and the present systems and methods (graph 414, shown in FIG. 4F). When comparing the present systems and methods between traditional SVD and traditional graphlet decomposition, graphs 410, 414 (shown in FIGS. 4D, 4F) illustrate that, at first glance, the coefficients may appear to be similar between those produced by the present methods and SVD. However, the present methods also perform as well as graphlet decomposition in distinguishing the two networks. For example, graph 412 compared with graph 414 (shown in FIGS. 4E, 4F) illustrates that the present systems and methods also perform as well as graphlet decomposition in distinguishing between two networks. This demonstrates that community structure as selected by the present systems and methods is a natural basis for interpreting social networks. By decomposing a network into cliques, the present systems and methods provide an efficient transformation that is concise and easier to analyze than SVD bases as illustrated in graph 410 (shown in FIG. 4D), which are constrained through their requirement to be orthogonal.

FIGS. 4G-4I also illustrate exemplary results from testing traditional systems and methods against the present systems and methods, in accordance with certain embodiments of the present invention. Graphs 420, 422, and 424 illustrate the ability to discriminate between the five categories described in Table 2, using traditional singular value decomposition (SVD) methods (graph 420, shown in FIG. 4G), traditional graphlet decomposition methods (graph 422, shown in FIG. 4H), and the present systems and methods (graph 424, shown in FIG. 4I). Graphs 420 and 424 (shown in FIGS. 4G, 4I) verify that, at first glance, the coefficients may appear to be similar between those produced by the present methods and SVD. However, graphs 422 and 424 (shown in FIGS. 4H, 4I) verify that the present methods also perform as well as graphlet decomposition in distinguishing the networks. As described earlier in connection with FIGS. 4D-4F, this demonstrates that community structure as selected by the present systems and methods is a natural basis for interpreting social networks. By decomposing a network into cliques, the present systems and methods provide an efficient transformation that is concise and easier to analyze than SVD bases as illustrated in graph 420, which are constrained through their requirement to be orthogonal.

Finally, Table 2 illustrates performance of the present systems and methods to summarize consistently each network according to category. The present example then clustered all coefficients using k-means. During this investigation, it became clear that singular value decomposition (SVD) could not identify the category of network being analyzed (see graphs 410, 420, shown in FIGS. 4D, 4G). Because the present systems and methods select community structure (i.e., cliques) as bases, the ability of the present systems and methods to identify a network is considerably improved. The present methods are also more accurate in clustering than traditional graphlet decomposition. Therefore, the Bernoulli Distribution used in the present systems and methods is a simpler and more natural process for generating networks. The present systems and methods are also easier to interpret and do not run the risk of getting stuck in local minima, unlike traditional graphlet methods.

In addition to the statistical model described above, the present system includes further embodiments for identifying persons of interest using network graphs.

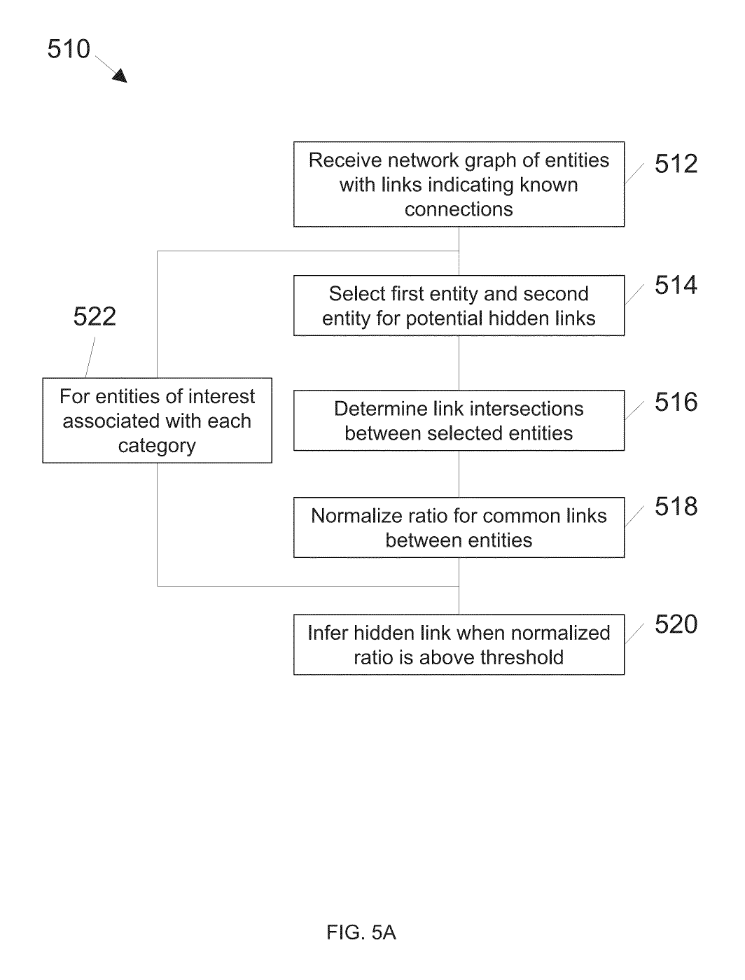

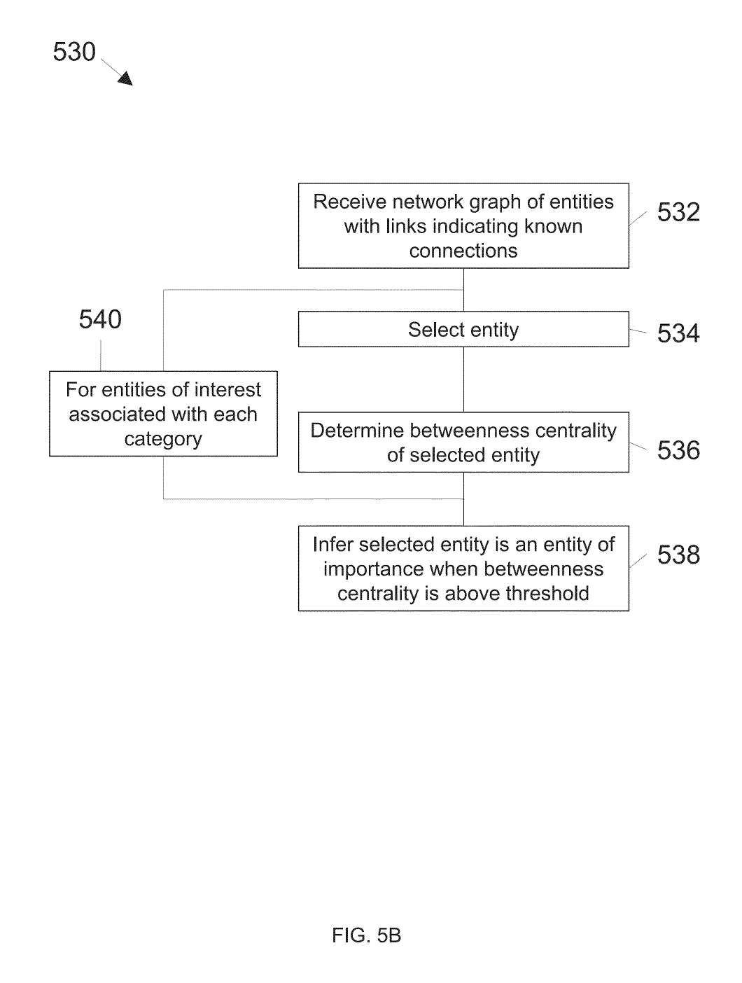

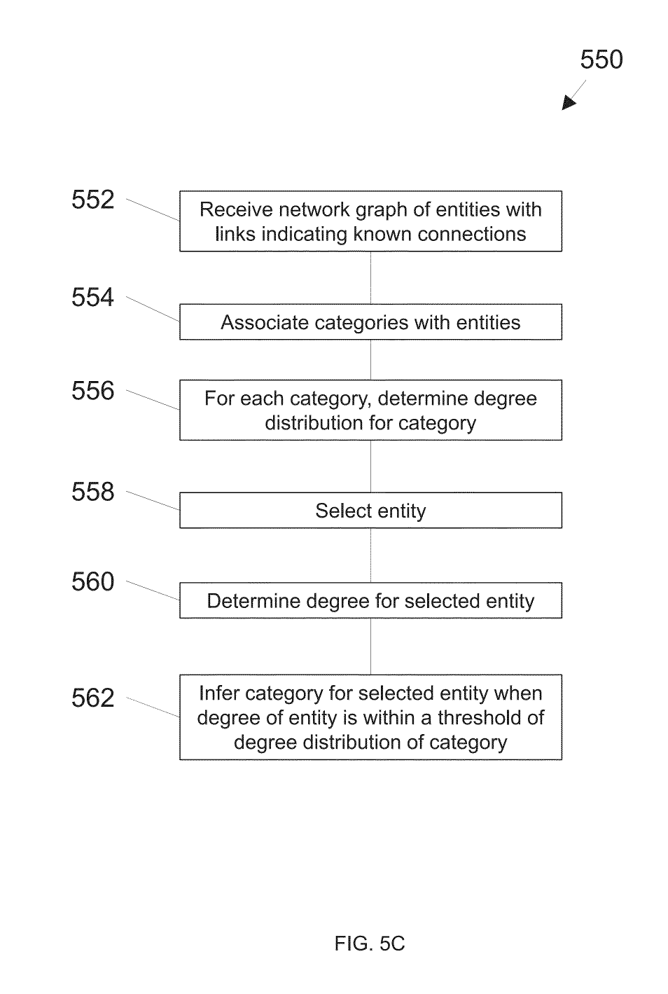

FIG. 5A illustrates an exemplary process 510 for inferring hidden links among persons of interest in a network graph, in accordance with certain embodiments of the present invention. As described earlier, the present system receives and analyzes a network graph of entities (i.e., nodes or persons of interest), and the network graph may have links or edges indicating known connections (step 512). The present system selects first and second entities from the network graph for analysis (step 514). The first entity may be a “known” entity, in the sense that its affiliation with a category, activity, or type (shown in FIG. 2B) is already known. For example, the first entity may be chosen from among a “seed list” of entity identifiers. The second entity may represent a person of interest that is unknown. The present system uses the network graph to infer hidden links between the first and second entity.

The present system determines link intersections between the first and second entities (step 516). In some embodiments, the present system determines link intersections as follows. Let the first entity be node A and let the second entity be node B. The present system counts links, or acquaintances, of A and B, denoted N(A) and N(B), respectively. The links might intersect, and the more that A and B have in common, the higher the likelihood they may themselves be friends. The present system calculates N(A) ∩ N(B).

The present system normalizes the ratio to account for common links between A and B (step 518). That is, the present system determines

$$λ ( A , B ) = \frac{N ( A ) ⋂ N ( B )}{N ( A ) ⋃ N ( B )} \qquad ( Equation 11 )$$

This is because two individuals A′ and A″ might have, for example, 10 mutual friends in common with B. However, the total number of friends for A′ may be 10, whereas the total number of friends for A″ may be 100. The conclusions drawn when comparing A′ to B, with all friends of A′ in common, would be very different from the conclusions drawn when comparing A″ to B, with only 10 of 100 friends of A″ in common. The present system proceeds to infer hidden links between the first and second entities when the normalized ratio λ(A, B) is above a threshold (step 520).

In some embodiments, the present system performs process 510 on a per-category basis (step 522). That is, the present system separates individuals by activity and analyzes the individuals separately. For example, given a person of interest B, the present system can determine λ(A, B) for varying nodes A that belong to different categories. This embodiment has the advantage of accounting for dealing with different groups of people with different numbers of links in common.

FIG. 5B illustrates another example process 530 for detecting persons of interest in a network graph, in accordance with certain embodiments of the present invention. Similar to FIG. 5A, the present system receives and analyzes a network graph of entities (i.e., nodes or persons of interest), and the network graph may have links or edges indicating known connections (step 532). The present system selects an entity from the network graph for analysis (step 534). The selected entity may represent a person of interest that is unknown. The present system uses the network graph to infer whether the node represents a person of interest.

The present system determines a modified version of “betweenness centrality” of the selected entity (step 536). The present betweenness centrality represents the most “important” people in a network. Specifically, vertex and edge betweenness may be defined by the number of shortest paths going through a vertex, or connection of people. Betweenness measures the number of shortest paths from all nodes to all others, which pass through a selected node (i.e., the selected entity). If the selected entity has a high betweenness centrality, the present system determines the selected entity in the network graph to be important because the entity appears in so many shortest paths. In other words, deleting the entity would likely disconnect other members of the group.

Table 3 compares process 530 with traditional implementations (i.e., SBSS).

TABLE 3
Comparison of process 530 with traditional methods

| Entity Index | Betweenness | Traditional |
|---|---|---|
| 3969 | 6.5790833E8 | 100 |
| 9398 | 5.10084444E8 | 100 |
| 97771 | 3.93676174E8 | 100 |
| 67759 | 3.91628806E8 | 100 |
| 12582 | 3.36524651E8 | 100 |
| 6161 | 3.12892965E8 | 100 |
| 14928 | 2.86040347E8 | 100 |
| 2692 | 2.56669444E8 | 100 |
| 33570 | 2.39793368E8 | 100 |
| 3741 | 2.25039412E8 | 100 |

As shown in Table 3, results from process 530 correlate well with independent results from traditional scores (i.e., individuals with high traditional scores of 100 also had high scores according to the present modified betweenness centrality). Furthermore, results from process 530 are significantly more fine-grained than traditional results from SBSS (i.e., there is a range of scores according to the present modified betweenness centrality, whereas traditional scores are bunched at 100). The present system uses the modified betweenness centrality scores to infer that a selected node is of interest when the betweenness centrality score is above a certain threshold (step 538).

Similar to FIG. 5A, in some embodiments, the present system performs process 530 on a per-category basis (step 540). That is, the present system separates individuals by activity and analyzes the individuals separately. This embodiment has the advantage of accounting for dealing with different groups of people with different numbers of links in common.

FIG. 5C illustrates another example process 550 for inferring an associated category for a person of interest in a network graph, in accordance with certain embodiments of the present invention. The present system receives a network graph of entities (also referred to as nodes or vertices), where links or edges between the entities represent explicit connections between the entities (step 552). The present system associates categories with the entities (i.e., persons of interest) (step 554). For each category, the present system determines a degree distribution for the category (step 556). The degree distribution measures a range of degrees (i.e., edges or connections) associated with each entity in the category. In some embodiments, the present system can also determine an appropriate degree distribution by comparing two categories. The present system calculates an L² norm for at least some of the entities belonging to each category. The L² norm generally measures how statistically close each degree of the entities is to the mean or median degree of the related category, and measures how statistically dispersed the entities are from the mean or median degree of the related category. If the L² norm is non-zero and sufficiently large, the present system can conclude that the two categories are distinguishable. The present system can select the degree distribution to be within the calculated L2 norm, to avoid overlap with the other category. In some embodiments, the present system can also determine Kullback-Liebler divergence (K-L divergence) of the categories, rather than the L² norm. Generally, the Kullback-Liebler divergence represents another measure of divergence or relative entropy between two statistical distributions.

The present system selects an entity representing a person of interest (step 558). The present system then determines a degree (i.e., number of edges or connections) associated with the person of interest in the network graph (step 560). The present system infers a category for the person of interest, based on the degree for the person of interest and on the degree distribution for each category (step 562). In some embodiments, the present system identifies categories for which the determined degree for the person of interest is within a threshold of the degree distribution determined for a particular category.

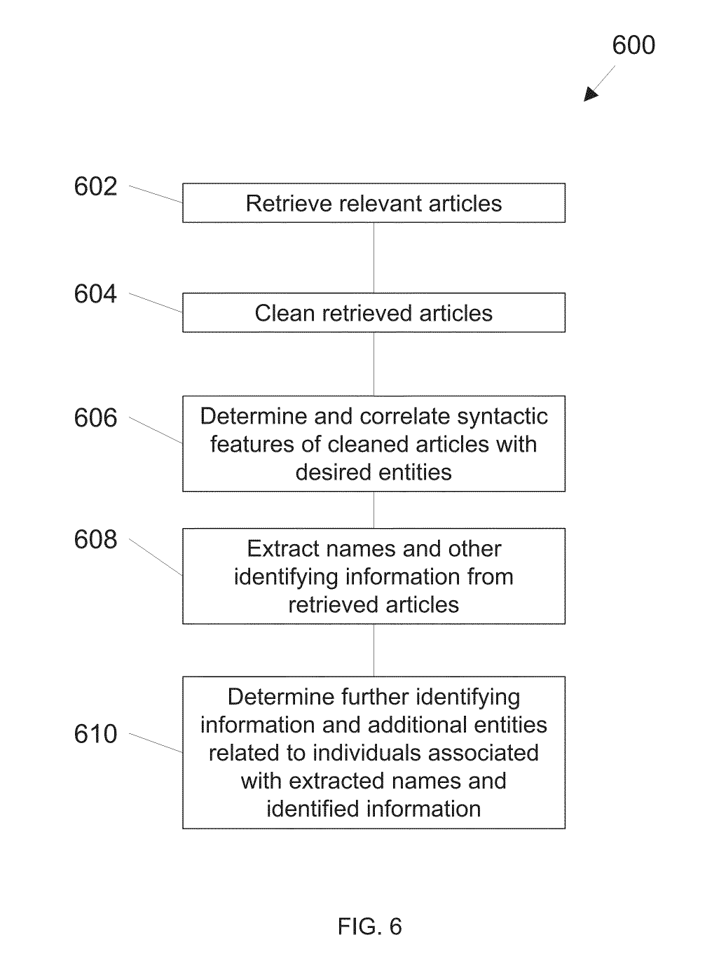

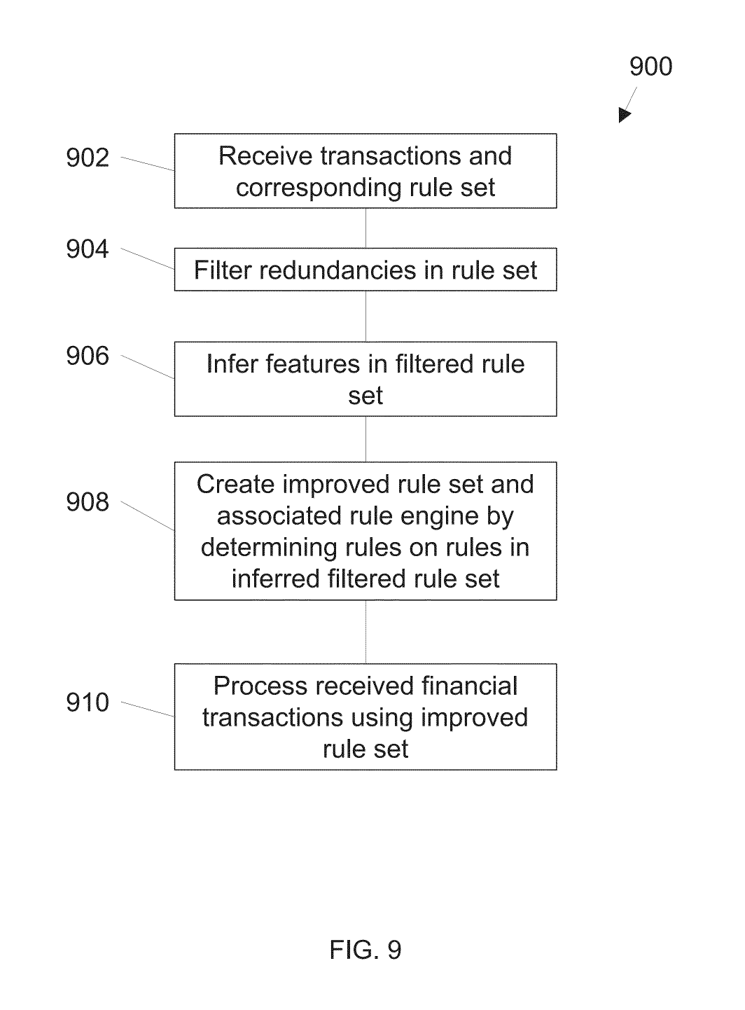

The processes illustrated in connection with FIGS. 3 and 5A-5C may be performed in combination with each other, or in combination with the processes illustrated in connection with FIGS. 6 and 9 as described in further detail below.

### Generation of Names Linked to Illegal Activities

In addition to or instead of the network graph analysis described above, the present systems and methods may also scour the Internet to generate names of persons of interest who may be linked to illegal activities. As described in further detail below, the present system is able to scour the Internet to extract salient information relating to persons of interest. The present system extracts the salient information using combinations of natural language processing, link analysis, data mining, and machine learning. The present system cross-connects the extracted information to client databases at client institutions that are interested in the information, such as financial institutions.

FIG. 6 illustrates an exemplary process 600 for generating names of persons of interest linked to illegal activities, in accordance with certain embodiments of the present invention. The present system retrieves articles of interest (step 602). In some embodiments, the present system may retrieve news articles, police updates, reporting agencies, keyword searches, or content from other relevant web sites. The keyword searches may relate to illegal activities, be based on client-specific needs, or be derived through consultation on criminal activities. The present system proceeds to clean the retrieved articles (step 604). In some embodiments, the present system cleans the retrieved content by removing HyperText Markup Language (HTML) tags, advertising, and other content deemed not to be useful to the substantive content.

The present system determines syntactic features of the cleaned articles and correlates the syntactic features with desired entities (step 606). In some embodiments, the present system combines natural language processing (NLP) with link analysis. In further embodiments, the present system determines syntactic features using NLP for sentence segmentation, work tokenization, part-of-speech tagging, named entity recognition, and co-reference. The present system correlates the above syntactic features with desired entities by processing the above information using heuristics on keywords deemed to be important, along with machine learning models. The present system stores the desired entities in a database, along with extracted identifying information and a context for the match. An example database schema is shown later in connection with FIG. 7 and the accompanying description.

The present system creates the machine learning models using manually annotated data and the heuristic extractions described earlier. The present system learns the machine learning models by classification using boosted decision trees. A boosted decision tree refers to a classification tree data structure that the present system uses to determine a machine learning model that matches syntactic features of the cleaned articles to desired entities associated with persons of interest. The decision tree is “boosted” by iteratively reevaluating training events that are misclassified according to the current decision tree.

The present system extracts names and other identifying information from the retrieved articles (step 608). In some embodiments, the present system extracts the identifying information using syntactic heuristics and by models created in a similar fashion to the entity identification machine learning models described earlier.

The present system proceeds to determine further identifying information and additional entities related to the individuals associated with the existing extracted names and identified information (step 610). The present system searches for further articles on identified individuals and further information related to the identified article. The present system searches for both further identifying information, and also additional entities related to reported or suspected criminal activities. In some embodiments, the present system uses natural language processing, data mining, and machine learning to identify the further identifying information and additional entities. Traditionally, financial institutions and other institutions scanned media in a substantially manual fashion. At most, financial institutions would configure automated alerts for a name of interest. Therefore, traditional systems were unable to determine the further identifying information and additional related entities available with the present systems and methods.

FIG. 7 illustrates an exemplary database schema 700 for generating names of persons of interest linked to illegal activities, in accordance with certain embodiments of the present invention. As described earlier in connection with FIG. 6, the present system stores and retrieves the following information in the database: desired entities along with extracted identifying information and a context for a match. Database schema 700 describes database tables and relations between the tables that may be configured to store the desired information. In general, database schema 700 stores queries, articles, entities, and user actions. Database schema 700 also stores an initial set of query topics and search terms.

FIG. 8A illustrates an exemplary user interface 800 for generating names of persons of interest linked to illegal activities, in accordance with certain embodiments of the present invention. FIG. 8A illustrates a search topic 802, a number of threaded articles 804, and a related entity 806. User interface 800 allows a user to select a search topic 802 of interest. As shown in the left-hand sidebar, example topics include All, Bombing, Bribery, Child Porn, Corruption, Drug, Elder Abuse, Fraud, Grow Op, Grow Op Bust, ID Theft, Money Laundering, Ponzi, Scam, and Terror. If the user selects Terror, then user interface 800 displays a number of threaded articles 804. As described in connection with FIGS. 6 and 7 and accompanying description, the present system is able to identify further names and entities of interest. User interface 800 displays related entity 806 that the present system detected by further analyzing a selected article from threaded articles 804. For example, user interface 800 displays related entity “Mouna Diab,” age 26, who was detected with a confidence level of 50%.

FIG. 8B illustrates another example user interface 810 for generating names of persons of interest linked to illegal activities, in accordance with certain embodiments of the present invention. FIG. 8B illustrates the same Terror topic and entity “Mouna Diab.” Upon receiving a selected article, user interface 810 is able to highlight mentions 812a-d of the desired entity (Mouna Diab).

FIG. 8C illustrates another example user interface 820 for generating names of persons of interest linked to illegal activities, in accordance with certain embodiments of the present invention. User interface 820 also allows a user to search for entities of interest. For example, the user may enter a search term 822 “mouna,” and the present system displays articles of interest. FIG. 8C illustrates one article result expanded.

### Automated Analysis of Rule Sets

In addition to or instead of the network graph analysis and name generation described earlier, the present systems and methods may also perform automated analysis of rule sets regarding transactions relating to persons of interest, so as to create more efficient rule sets for identifying suspicious transactions. Generally, given one or more rule sets as input, the present system determines “rules on rules,” or meta-rules about the rule sets. The present system creates “black-box” combinations of existing rule sets to create a higher-performance rules engine, “gray-box” analysis of rule sets to detect redundancies, and “white-box” analysis to infer features of rules and create improved rule sets and an improved rules engine.

FIG. 9 illustrates an exemplary process 900 for automated analysis of rule sets, in accordance with certain embodiments of the present invention. The present system allows users to automatically detect suspicious transactions and patterns to identify suspicious activities or financial accounts. The present system receives transactions of interest and rule sets for processing the received transactions (step 902). A rule set describes rules for identifying or flagging transactions, activities, or accounts as suspicious. For example, a rule of a rule set might state “if transaction_amount>US$10,000 then transaction=suspicious.” This example rule identifies or flags any transactions involving an amount greater than US$10,000 as suspicious. In response, a bank or other financial institution might automatically require approval for all transactions greater than US$10,000.

The present system detects and filters redundancies in the rule set (step 904). In some embodiments, the present system may perform “gray-box” analysis of the received rule set to detect redundancies. The present system infers features of the remaining rules in the rule set (step 906). In some embodiments, the present system may perform “white-box” analysis of the remaining rules to infer features. The white-box analysis may create an improved rule set and associated rules processing engine (step 908). In some embodiments, the present system may also perform “black-box” combinations of existing rule sets to create a higher precision rules processing engine. For example, the present system may learn “rules on rules,” or meta-rules that describe the rules that the system is processing. The present system may post-process events output from the initial rules, to improve precision. Finally, the present system processes the received transactions using the improved rule set and improved rules processing engine (step 910).

The present system uses machine learning to automatically find good rules to filter incoming transactions of interest to financial institutions. The rules processing may be used to identify transactions associated with accounts or activities related to persons of interest. The present system finds improved rules that have greater precision than traditional rules, and are simpler to understand by users. The present system also improves “recall,” such that the present system identifies more truly suspicious accounts while avoiding false positive accounts that are not truly suspicious.

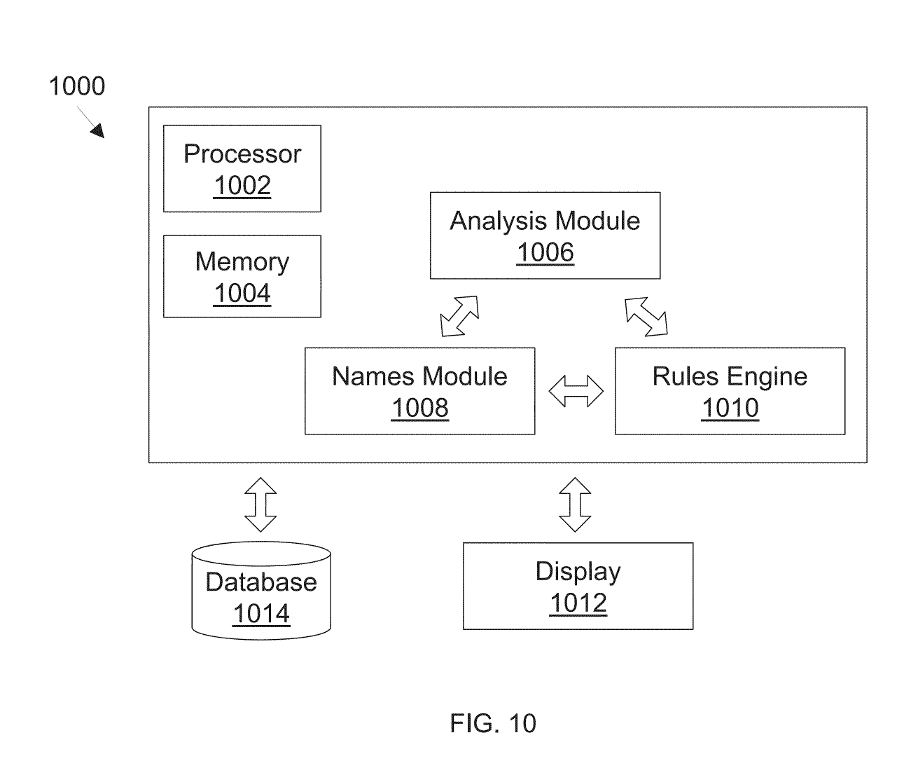

FIG. 10 illustrates an exemplary computer system implementing the present analysis framework for persons of interest, in accordance with certain embodiments of the present invention. Computing device 1000 includes processor 1002 and memory 1004, in communication with analysis module 1006, names module 1008, and rules engine 1010. In some embodiments, processor 1002 represents multiple processors, or multiple cores running on one processor. In some embodiments, processor 1002, memory 1004, analysis module 1006, names module 1008, and/or rules 1010 use database 1014 for storage. For example, computing device 1000 may store network data relating to persons of interest such as a network graph data structure. Similarly, computing device 1000 may store rules and rules-on-rules relating to persons of interest for processing by rules engine 1010. Database 1014 may also store retrieved articles from the Internet regarding persons of interest for processing using names module 1008. Display 1012 may interact with the user to display the exemplary user interfaces illustrated in FIGS. 8A-8C, or display other user interfaces relating to the present systems and methods.

Although FIG. 10 illustrates single modules for analysis module 1006, names module 1008, and rules engine 1010, any of these modules may be subdivided into separate modules, such as a first analysis module (e.g., for network graph analysis according to the present statistical model), and a second analysis module (e.g., for inferring hidden links in network graphs). Alternatively, these modules may be implemented in one or more common modules.

Other embodiments are within the scope and spirit of the present systems and methods. For example, the functionality described above can be implemented using software, hardware, firmware, hardwiring, or combinations of any of these. One or more computer processors operating in accordance with instructions may implement the functions associated with analytic frameworks for persons of interest in accordance with the present disclosure as described above. If such is the case, it is within the scope of the present disclosure that such instructions may be stored on one or more non-transitory processor readable storage media (for example, a magnetic disk or other storage medium). Additionally, as described earlier, modules implementing functions may also be physically located at various positions, including being distributed such that portions of functions are implemented at different physical locations.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A system for identifying persons of interest using network data, the system comprising:
a memory for storing network data regarding persons of interest, wherein the network data is stored as a network graph of persons of interest, and wherein the network graph represents individual people as nodes in the network graph and connections between the people as edges in the network graph;
a display for rendering a computer-implemented user interface regarding the persons of interest; and
at least one processor coupled to the memory and to the display, the processor configured to:
determine a statistical model representing the network graph, the statistical model generating hidden parameters modeling the network data, for decomposing and projecting the network graph onto a space of baseline communities;
categorize cliques of nodes in the network graph as the space of baseline communities based at least in part on the statistical model;
infer a category for a received potential person of interest by determining a node corresponding to the received potential person of interest and associating a clique from the categorized cliques of nodes to the node corresponding to the received potential person of interest, and wherein the inferred category for the potential person of interest identifies the potential person of interest as suspicious; and
render, using the display, the inferred category for the received person of interest.

2. The system of claim 1, wherein the inferred categories include at least one of Suspicious Individuals, Convicted Individuals, Legal/Lawyer Professionals, Political Individuals, Politically Exposed Individuals, Terrorists, Suspected Terrorists, Bank, Blacklisted, Corporate, Country, Crime, Diplomat, Embargo, Individual, Legal, Military, Organization, Political, Port, Religion, Terrorism, Trade, and Vessel.

3. The system of claim 1, wherein the statistical model generates the hidden parameters for reconstructing the network graph.

4. The system of claim 1, wherein the categorizing the cliques of nodes further comprises (i) determining power relationships between baseline cliques, and (ii) determining commonalities between the network graph and the baseline cliques.

5. The system of claim 1, wherein the network graph is unweighted, wherein the network graph does not adhere to a power law, and wherein the network graph does not exhibit small world phenomena.

6. The system of claim 1, wherein the categorizing the cliques of nodes further comprises identifying maximal cliques in the network graph using the Bron-Kerbosch algorithm.

7. The system of claim 3, wherein the determining the parameters for reconstructing the network graph further including solving for the parameters according to a least squares solution.

8. A computer-implemented method for identifying persons of interest using network data, the method comprising:
storing, in a computer memory, network data regarding persons of interest, wherein the network data is stored as a network graph of persons of interest, and wherein the network graph represents individual people as nodes in the network graph and connections between the people as edges in the network graph;
rendering, on a display, a user interface regarding the persons of interest;
determining a statistical model representing the network graph, the statistical model generating hidden parameters modeling the network data, for decomposing and projecting the network graph onto a space of baseline communities;
categorizing cliques of nodes in the network graph as the space of baseline communities based at least in part on the statistical model;
inferring a category for a received potential person of interest by determining a node corresponding to the received potential person of interest and associating a clique from the categorized cliques of nodes to the node corresponding to the received potential person of interest, and wherein the inferred category for the potential person of interest identifies the potential person of interest as suspicious; and
rendering, using the display, the inferred category for the received person of interest.

9. The method of claim 8, wherein the inferred categories include at least one of Suspicious Individuals, Convicted Individuals, Legal/Lawyer Professionals, Political Individuals, Politically Exposed Individuals, Terrorists, Suspected Terrorists, Bank, Blacklisted, Corporate, Country, Crime, Diplomat, Embargo, Individual, Legal, Military, Organization, Political, Port, Religion, Terrorism, Trade, and Vessel.

10. The method of claim 8, wherein the statistical model generates the hidden parameters for reconstructing the network graph.

11. The method of claim 8, wherein the categorizing the cliques of nodes further comprises (i) determining power relationships between baseline cliques, and (ii) determining commonalities between the network graph and the baseline cliques.

12. The method of claim 8, wherein the network graph is unweighted, wherein the network graph does not adhere to a power law, and wherein the network graph does not exhibit small world phenomena.

13. The method of claim 8, wherein the categorizing the cliques of nodes further comprises identifying maximal cliques in the network graph using the Bron-Kerbosch algorithm.

14. The method of claim 10, wherein the determining the parameters for reconstructing the network graph further including solving for the parameters according to a least squares solution.

15. A non-transitory computer program product for identifying persons of interest using network data, tangibly embodied in a computer-readable medium, the computer program product including instructions operable to cause a data processing apparatus to:
store, in a computer memory, network data regarding persons of interest, wherein the network data is stored as a network graph of persons of interest, and wherein the network graph represents individual people as nodes in the network graph and connections between the people as edges in the network graph;
render, on a display, a user interface regarding the persons of interest;
determine a statistical model representing the network graph, the statistical model generating hidden parameters modeling the network data, for decomposing and projecting the network graph onto a space of baseline communities;
categorize cliques of nodes in the network graph as the space of baseline communities based at least in part on the statistical model;
infer a category for a received potential person of interest by determining a node corresponding to the received potential person of interest and associating a clique from the categorized cliques of nodes to the node corresponding to the received potential person of interest, and wherein the inferred category for the potential person of interest identifies the potential person of interest as suspicious; and
render, using the display, the inferred category for the received person of interest.

16. The computer program product of claim 15, wherein the inferred categories include at least one of Suspicious Individuals, Convicted Individuals, Legal/Lawyer Professionals, Political Individuals, Politically Exposed Individuals, Terrorists, Suspected Terrorists, Bank, Blacklisted, Corporate, Country, Crime, Diplomat, Embargo, Individual, Legal, Military, Organization, Political, Port, Religion, Terrorism, Trade, and Vessel.

17. The computer program product of claim 15, wherein the statistical model generates the hidden parameters for reconstructing the network graph.

18. The computer program product of claim 15, wherein the instructions operable to cause the data processing apparatus to categorize the cliques of nodes further comprise instructions operable to cause the data processing apparatus (i) to determine power relationships between baseline cliques, and (ii) to determine commonalities between the network graph and the baseline cliques.

19. The computer program product of claim 15, wherein the network graph is unweighted, wherein the network graph does not adhere to a power law, and wherein the network graph does not exhibit small world phenomena.

20. The computer program product of claim 8, wherein the instructions operable to cause the data processing apparatus to categorize the cliques of nodes further comprise instructions operable to cause the data processing apparatus to identify maximal cliques in the network graph using the Bron-Kerbosch algorithm.
